(19) United States
(12) Patent Application Publication
(10) Pub. No.: US 2022/0089178 A1
(43) Pub. Date: Mar. 24, 2022

(54) CONTROL SYSTEM OF UNMANNED VEHICLE AND CONTROL METHOD OF UNMANNED VEHICLE

(71) Applicant: Komatsu Ltd., Tokyo (JP)

(72) Inventors: Tatsuya Shiga, Tokyo (JP); Yoshiaki Itakura, Tokyo (JP)

(73) Assignee: Komatsu Ltd., Tokyo (JP)

(21) Appl. No.: 17/417,616

(22) PCT Filed: Nov. 21, 2019
(86) PCT No.: PCT/JP2019/045653

§ 371 Date: Jun. 23, 2021

(30) Foreign Application Priority Data
Jan. 31, 2019 (JP) 2019-016467

(51) Int. Cl. B60W 60/00; B60Q 1/34; B60W 40/08

(52) U.S. Cl. CPC B60W 60/001; B60W 40/08; B60Q 1/34; B60W 60/0053

(57) ABSTRACT

A control system of an unmanned vehicle includes: a switching unit that can switch the unmanned vehicle, which has blinkers, between a manual mode and an automatic mode; a determination unit that determines whether the blinkers are operated; and a traveling control unit that controls traveling of the unmanned vehicle on the basis of determination data of the determination unit.

### FIELD

The present disclosure relates to a control system of an unmanned vehicle and a control method of the unmanned vehicle.

### BACKGROUND

There is a case where an unmanned vehicle is used at a wide work site such as a mine. The unmanned vehicle can be operated in either a manual mode of being operated by driving operation by a driver or an automatic mode of being operated in an unmanned manner without the driving operation by the driver.

### CITATION LIST

### Patent Literature

Patent Literature 1: Japanese Patent Application Laid-open No. 2015-056134

### SUMMARY

### Technical Problem

At a work site, not only an unmanned vehicle but also a manned vehicle are operated. In a case where a blinker is provided in the unmanned vehicle, a worker on the manned vehicle can recognize a moving direction of the unmanned vehicle. On the one hand, when the blinker is operated unnecessarily, the worker on the manned vehicle cannot correctly recognize the moving direction of the unmanned vehicle.

### Solution to Problem

According to an aspect of the present invention, a control system of an unmanned vehicle, comprises: a switching unit that can switch the unmanned vehicle, which has a blinker, between a manual mode and an automatic mode; a determination unit that determines whether the blinker is operated; and a traveling control unit that controls traveling of the unmanned vehicle on the basis of determination data of the determination unit.

### Advantageous Effects of Invention

According to an aspect of the present invention, it is possible to prevent an unmanned vehicle from traveling in an automatic mode in a state in which a blinker is operated unnecessarily.

### BRIEF DESCRIPTION OF DRAWINGS

FIG. 1 is a view schematically illustrating an example of a control system, an unmanned vehicle, and a manned vehicle according to an embodiment.

FIG. 2 is a view schematically illustrating an example of a work site according to the embodiment.

FIG. 3 is a functional block diagram illustrating an example of a management device and a control device according to the embodiment.

FIG. 4 is a flowchart illustrating an example of a control method of the unmanned vehicle according to the embodiment.

FIG. 5 is a block diagram illustrating an example of a computer system.

### DESCRIPTION OF EMBODIMENTS

In the following, embodiments according to the present disclosure will be described with reference to the drawings, but the present invention is not limited thereto. Components of the embodiments described in the following can be arbitrarily combined. Also, there is a case where a part of the components is not used.

[Control System]

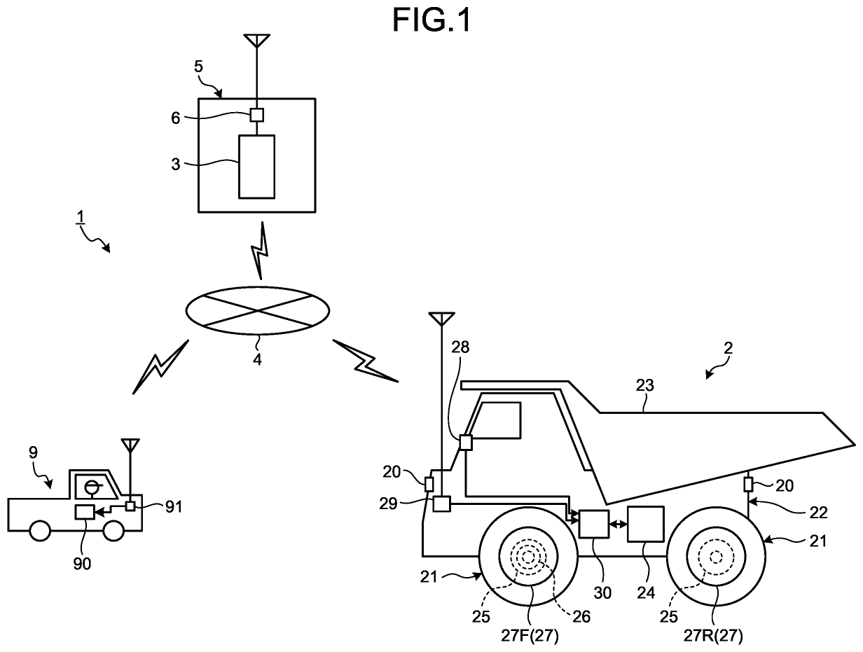

FIG. 1 is a view schematically illustrating an example of a control system 1, an unmanned vehicle 2, and a manned vehicle 9 according to the present embodiment. In the present embodiment, the unmanned vehicle 2 means a vehicle that can operate in an unmanned manner without driving operation by a driver. The unmanned vehicle 2 operates at a work site.

The control system 1 includes a management device 3 and a communication system 4. A control system includes the control system 1 and the unmanned vehicle 2. The management device 3 includes a computer system and is installed in a control facility 5 in a mine. The communication system 4 performs communication between the management device 3 and the unmanned vehicle 2. Wireless communication equipment 6 is connected to the management device 3. The communication system 4 includes the wireless communication equipment 6. The management device 3 and the unmanned vehicle 2 perform wireless communication through the communication system 4.

[Unmanned Vehicle]

The unmanned vehicle 2 operates at a work site on the basis of traveling course data from the management device 3. The unmanned vehicle 2 includes a blinker 20, a traveling device 21, a vehicle body 22 supported by the traveling device 21, a dump body 23 supported by the vehicle body 22, and a control device 30.

The blinker 20 is a direction indicator that displays a moving direction of the unmanned vehicle 2. The blinker 20 is arranged at each of a front part and a rear part of the vehicle body 22. When the blinkers 20 are operated, a moving direction of the unmanned vehicle 2 is notified to the surroundings. Each of the blinkers 20 includes blinker lamps. Operation of the blinkers 20 includes lighting or blinking of the blinker lamps. An operation stop of the blinkers 20 includes turning off of the blinker lamps. Each of the blinkers 20 includes a right blinker lamp that lights or blinks when the unmanned vehicle 2 turns right, and a left blinker lamp that lights or blinks when the unmanned vehicle 2 turns left. The right blinker lamp is arranged in a right part of the vehicle body 22. The left blinker lamp is arranged in a left part of the vehicle body 22. Also, hazard lighting in which the right blinker lamps and the left blinker lamps light or blink at the same time can be performed in the blinkers 20.

The traveling device 21 includes a drive device 24 that drives the traveling device 21, a brake device 25 that brakes the traveling device 21, a steering device 26 that adjusts a traveling direction, and wheels 27.

The unmanned vehicle 2 travels autonomously by a rotation of the wheels 27. The wheels 27 include front wheels 27F and rear wheels 27R. Tires are attached to the wheels 27.

The drive device 24 generates driving force to accelerate the unmanned vehicle 2. The drive device 24 includes an internal combustion engine such as a diesel engine. Note that the drive device 24 may include an electric motor. Power generated by the drive device 24 is transmitted to the rear wheels 27R. The brake device 25 generates braking force to decelerate or stop the unmanned vehicle 2. The steering device 26 can adjust a traveling direction of the unmanned vehicle 2. The traveling direction of the unmanned vehicle 2 includes a direction of the front part of the vehicle body 22. The steering device 26 adjusts the traveling direction of the unmanned vehicle 2 by steering the front wheels 27F.

The control device 30 is arranged in the unmanned vehicle 2. The control device 30 can communicate with the management device 3 existing outside the unmanned vehicle 2. The control device 30 outputs an accelerator command to operate the drive device 24, a brake command to operate the brake device 25, and a steering command to operate the steering device 26. The drive device 24 generates driving force to accelerate the unmanned vehicle 2 on the basis of the accelerator command output from the control device 30. A traveling speed of the unmanned vehicle 2 is adjusted by an adjustment of the output of the drive device 24. The brake device 25 generates braking force to decelerate the unmanned vehicle 2 on the basis of the brake command output from the control device 30. On the basis of the steering command output from the control device 30, the steering device 26 generates force to change a direction of the front wheels 27F in order to cause the unmanned vehicle 2 to move straight ahead or to turn.

Also, the unmanned vehicle 2 includes a position detection device 28 that detects a position of the unmanned vehicle 2. A position of the unmanned vehicle 2 is detected by utilization of a global navigation satellite system (GNSS). The global navigation satellite system includes a global positioning system (GPS). The global navigation satellite system detects an absolute position of the unmanned vehicle 2 which position is defined by coordinate data of latitude, longitude, and altitude. With the global navigation satellite system, a position of the unmanned vehicle 2 which position is defined in a global coordinate system is detected. The global coordinate system is a coordinate system fixed to the earth. The position detection device 28 includes a GNSS receiver, and detects an absolute position (coordinate) of the unmanned vehicle 2.

Also, the unmanned vehicle 2 includes wireless communication equipment 29. The communication system 4 includes the wireless communication equipment 29. The wireless communication equipment 29 can wirelessly communicate with the management device 3.

[Manned Vehicle]

The manned vehicle 9 is operated by driving operation by a worker. The manned vehicle 9 has a driver's cabin which a worker gets on. Also, the manned vehicle 9 includes a control device 90 and wireless communication equipment 91. The communication system 4 includes the wireless communication equipment 91. The wireless communication equipment 91 can wirelessly communicate with the management device 3.

[Work Site]

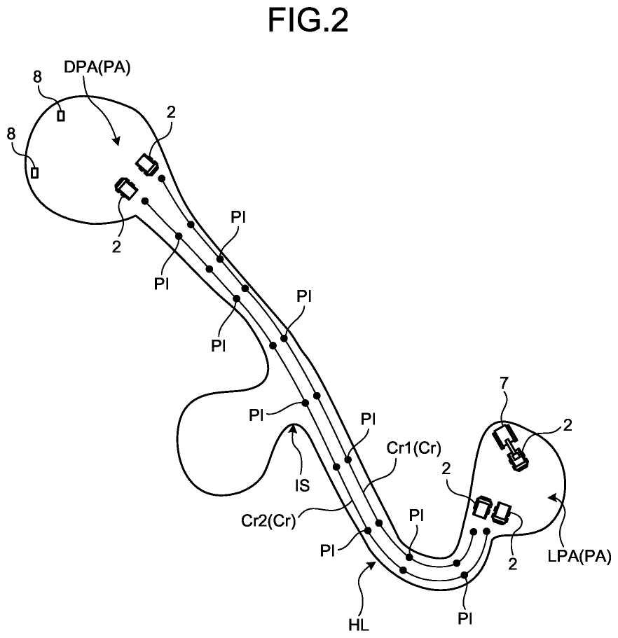

FIG. 2 is a view schematically illustrating an example of a work site according to the present embodiment. In the present embodiment, the work site is a mine or a quarry, and the unmanned vehicle 2 is a dump truck that travels at the work site and transports a load. The mine means a place or a plant where a mineral is mined. As a load to be transported by the unmanned vehicle 2, ore or dirt mined in the mine or the quarry is exemplified.

The unmanned vehicle 2 travels in at least a part of a workplace PA in the mine and a traveling path HL leading to the workplace PA. The workplace PA includes at least one of a loading place LPA and a dirt dumping place DPA. The traveling path HL includes an intersection IS.

The loading place LPA means an area where loading operation of loading a load on the unmanned vehicle 2 is performed. In the loading place LPA, a loader 7 such as an excavator operates. The dirt dumping place DPA means an area where dumping operation of dumping a load from the unmanned vehicle 2 is performed. A crusher 8 is provided in the dirt dumping place DPA, for example.

A target traveling route CR is set in the traveling path HL and the workplace PA. The unmanned vehicle 2 travels on the traveling path HL according to the target traveling route CR. The target traveling route CR includes a target traveling route CR1 and a target traveling route CR2. For example, the unmanned vehicle 2 travels from the dirt dumping place DPA to the loading place LPA according to the target traveling route CR1, and travels from the loading place LPA to the dirt dumping place DPA according to the target traveling route CR2.

[Management Device and Control Device]

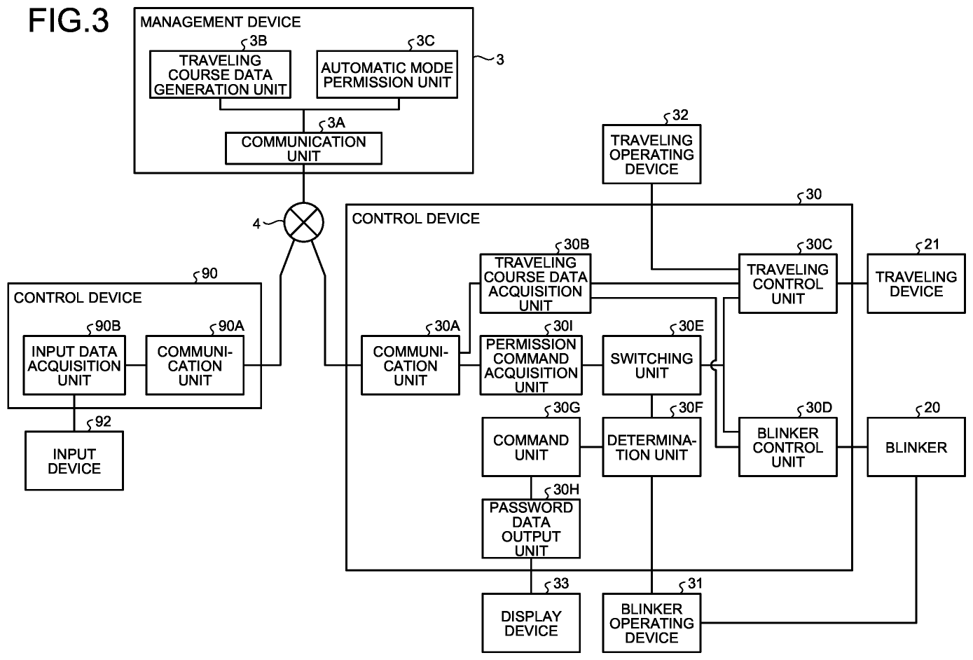

FIG. 3 is a functional block diagram illustrating an example of the management device 3, the control device 30, and the control device 90 according to the present embodiment. The control device 30 can communicate with the management device 3 through the communication system 4. The control device 90 can communicate with the management device 3 through the communication system 4.

The management device 3 includes a communication unit 3A, a traveling course data generation unit 3B, and an automatic mode permission unit 3C.

The communication unit 3A receives data transmitted from at least one of the control device 30 and the control device 90 through the communication system 4. Also, the communication unit 3A transmits data to at least one of the control device 30 and the control device 90 through the communication system 4.

The traveling course data generation unit 3B generates traveling course data including the target traveling route CR of the unmanned vehicle 2. As illustrated in FIG. 2, the traveling course data includes a plurality of points PI set at intervals. Each of the points PI defines a target position of the unmanned vehicle 2. The target traveling route CR is defined by a line connecting the plurality of points PI. A target traveling speed and a target traveling direction of the unmanned vehicle 2 are set for each of the plurality of points PI. Also, the traveling course data includes blinker data to control the blinkers 20. The blinker data is set for each of the plurality of points PI. The blinker data indicates an operating condition of the blinkers 20 of when the unmanned vehicle 2 passes through the point PI. The blinker data includes operation start data to start operation of the right blinker lamps, operation start data to start operation of the left blinker lamps, operation stop data to stop the operation of the right blinker lamps, and operation stop data to stop the operation of the left blinker lamps. The traveling course data generation unit 3B outputs the generated traveling course data to the communication unit 3A. The communication unit 3A transmits the traveling course data to the control device 30 of the unmanned vehicle 2.

The automatic mode permission unit 3C outputs a permission command that permits the unmanned vehicle 2 to operate in the automatic mode. In the present embodiment, the unmanned vehicle 2 can be operated in either a manual mode of being operated by driving operation by a driver on a driver's cabin of the unmanned vehicle 2 or an automatic mode of being operated in an unmanned manner on the basis of the traveling course data without the driving operation by the driver. In a case where the permission command is output from the automatic mode permission unit 3C, the unmanned vehicle 2 can operate in the automatic mode. In a case where the permission command is not output from the automatic mode permission unit 3C, the unmanned vehicle 2 cannot operate in the automatic mode.

For example, in a case where maintenance of the unmanned vehicle 2 traveling according to the target traveling route CR is performed, the unmanned vehicle 2 needs to travel from the target traveling route CR toward a maintenance site. When the unmanned vehicle 2 travels toward the maintenance site, traveling course data is not generated, and the unmanned vehicle 2 needs to travel toward the maintenance site by driving operation by the driver. Also, when the unmanned vehicle 2 returns from the maintenance site to the target traveling route CR, traveling course data is not generated, and the unmanned vehicle 2 needs to travel toward the target traveling route CR by the driving operation by the driver. Thus, the automatic mode and the manual mode are switched in the unmanned vehicle 2.

The control device 30 is connected to each of a blinker operating device 31, a traveling operating device 32, and a display device 33. Each of the blinker operating device 31, the traveling operating device 32, and the display device 33 is provided in the unmanned vehicle 2. A driver's cabin which the driver gets on in the manual mode is provided in the unmanned vehicle 2. Each of the blinker operating device 31, the traveling operating device 32, and the display device 33 is arranged in the driver's cabin of the unmanned vehicle 2.

The blinker operating device 31 is operated for operation and operation stop of the blinkers 20. A driver or worker on the driver's cabin of the unmanned vehicle 2 can operate the blinker operating device 31. The blinker operating device 31 includes a blinker lever capable of executing the operation and operation stop of the blinkers 20. Also, the blinker operating device 31 includes a hazard switch to cause hazard lighting of the blinkers 20. In the manual mode, the driver or worker can operate the blinkers 20 by operating the blinker operating device 31.

The traveling operating device 32 is operated for operation and operation stop of the traveling device 21. The driver or worker on the driver's cabin of the unmanned vehicle 2 can operate the traveling operating device 32. The traveling operating device 32 includes an accelerator pedal to arbitrate an output of the drive device 24, a brake pedal to operate the brake device 25, and a steering wheel to operate the steering device 26. In the manual mode, the driver or the worker can operate the traveling operating device 32 to operate the traveling device 21.

The display device 33 provides display data to the driver or worker on the driver's cabin of the unmanned vehicle 2. As the display device 33, a flat panel display such as a liquid crystal display (LCD) or an organic electroluminescence display (OELD) is exemplified.

The control device 30 includes a communication unit 30A, a traveling course data acquisition unit 30B, a traveling control unit 30C, a blinker control unit 30D, a switching unit 30E, a determination unit 30F, a command unit 30G, and a password data output unit 30H, and a permission command acquisition unit 30I.

The communication unit 30A transmits data to the management device 3 through the communication system 4. Also, the communication unit 30A transmits data to the manned vehicle 9 through the communication system 4. Also, the communication unit 30A receives data transmitted from the management device 3 through the communication system 4. Also, the communication unit 30A receives data transmitted from the manned vehicle 9 through the communication system 4.

The traveling course data acquisition unit 30B acquires the traveling course data that includes blinker data to control the blinkers 20 provided in the unmanned vehicle 2 and that is transmitted from the management device 3.

The traveling control unit 30C controls the traveling device 21 of the unmanned vehicle 2. The traveling control unit 30C controls traveling of the unmanned vehicle 2. In a case where the unmanned vehicle 2 is in the manual mode, the traveling control unit 30C controls the traveling device 21 on the basis of operation data generated by the operation of the traveling operating device 32. In a case where the unmanned vehicle 2 is in the automatic mode, the traveling control unit 30C controls the traveling device 21 on the basis of the traveling course data acquired by the traveling course data acquisition unit 30B.

The blinker control unit 30D controls the blinkers 20 of the unmanned vehicle 2. The blinker control unit 30D controls an operation state of the blinkers 20. In a case where the unmanned vehicle 2 is in the manual mode, the blinker control unit 30D controls the blinkers 20 on the basis of operation data generated by the operation of the blinker operating device 31. In a case where the unmanned vehicle 2 is in the automatic mode, the blinker control unit 30D controls the blinkers 20 on the basis of the blinker data included in the traveling course data acquired by the traveling course data acquisition unit 30B.

The switching unit 30E can switch the unmanned vehicle 2 between the manual mode and the automatic mode. The switching unit 30E outputs an automatic mode switching command to switch the unmanned vehicle 2 from the manual mode to the automatic mode, and a manual mode switching command to switch the unmanned vehicle 2 from the automatic mode to the manual mode. The switching unit 30E outputs at least one of the automatic mode switching command and the manual mode switching command to the traveling control unit 30C and the blinker control unit 30D.

For example, in a case where a changeover switch to perform switching between the manual mode and the automatic mode is provided in the driver's cabin of the unmanned vehicle 2, the switching unit 30E may perform switching between the manual mode and the automatic mode on the basis of operation data of the changeover switch.

In a case where the automatic mode switching command is output from the switching unit 30E, the traveling control unit 30C controls the traveling device 21 on the basis of the traveling course data. That is, the traveling control unit 30C controls the traveling device 21 in the automatic mode on the basis of the traveling course data. In a case where the manual mode switching command is output from the switching unit 30E, the traveling control unit 30C controls the traveling device 21 on the basis of the operation data of the traveling operating device 32. That is, the traveling control unit 30C controls the traveling device 21 in the manual mode on the basis of the operation data of the traveling operating device 32.

In the manual mode, in a case where the blinker operating device 31 is operated, switching from the manual mode to the automatic mode is prohibited. Also, in the manual mode, in a case where the blinker operating device 31 is operated, the unmanned vehicle 2 is prohibited from traveling in the automatic mode. In the manual mode, in a case where the blinker operating device 31 is not operated, switching from the manual mode to the automatic mode is permitted. Also, in the manual mode, in a case where the blinker operating device 31 is not operated, the unmanned vehicle 2 is permitted to travel in the automatic mode.

In a case where the automatic mode switching command is output from the switching unit 30E, the blinker control unit 30D controls the blinkers 20 on the basis of the blinker data included in the traveling course data. That is, the blinker control unit 30D controls the blinkers 20 in the automatic mode on the basis of the blinker data. In a case where the manual mode switching command is output from the switching unit 30E, the blinkers 20 are controlled on the basis of the operation data of the blinker operating device 31. That is, in the manual mode, the blinkers 20 are controlled on the basis of the operation data of the blinker operating device 31.

The determination unit 30F determines whether the blinkers 20 are operated in the manual mode. A state in which the blinkers 20 are operated includes not only a state in which the blinkers 20 are actively operated by the driver but also a state in which an operated state of the blinkers 20 is left unattended. From the blinker operating device 31, the determination unit 30F acquires the operation data generated by the operation of the blinker operating device 31. On the basis of the operation data of the blinker operating device 31, the determination unit 30F determines whether the blinkers 20 are operated in the manual mode. In a case where the manual mode switching command is output from the switching unit 30E and the operation data is acquired from the blinker operating device 31 in a state in which the unmanned vehicle 2 is set to the manual mode, the determination unit 30F determines that the blinkers 20 are operated in the manual mode.

On the basis of determination data of the determination unit 30F, the command unit 30G outputs a first command to set switching from the manual mode to the automatic mode to a permitted state, or a second command to set the switching to a prohibited state. In a case where the determination unit 30F determines that the blinkers 20 are not operated in the manual mode, the command unit 30G outputs the first command to set the switching from the manual mode to the automatic mode to the permitted state. In a case where the determination unit 30F determines that the blinkers 20 are operated in the manual mode, the command unit 30G outputs the second command to set the switching from the manual mode to the automatic mode to the prohibited state.

The traveling control unit 30C causes the unmanned vehicle 2 to travel in at least one of the manual mode and the automatic mode on the basis of the determination data of the determination unit 30F. The traveling control unit 30C controls a traveling state of the unmanned vehicle 2 at least in the automatic mode. The traveling control unit 30C prevents the unmanned vehicle 2 from traveling in a case where it is determined that the blinkers 20 are operated in the manual mode. In a case where it is determined that the blinkers 20 are operated in the manual mode, the traveling control unit 30C prevents the unmanned vehicle 2 from traveling in the automatic mode even when switching from the manual mode to the automatic mode is performed.

The password data output unit 30H outputs password data in the permitted state in which switching from the manual mode to the automatic mode is permitted. That is, the password data output unit 30H outputs the password data in a state in which the first command to set the switching from the manual mode to the automatic mode to the permitted state is output from the command unit 30G.

In the present embodiment, the password data includes a passcode. The password data includes, for example, a one time password (OTP). The one time password is a password that is automatically changed at regular intervals and is valid only once.

The password data output unit 30H outputs the password data to the display device 33. The display device 33 displays the password data.

The permission command acquisition unit 30I acquires a permission command generated in the automatic mode permission unit 3C on the basis of the password data. The switching unit 30E switches the unmanned vehicle 2 from the manual mode to the automatic mode in a case where the permission command output from the automatic mode permission unit 3C is acquired by the permission command acquisition unit 30I.

The control device 90 is connected to the input device 92. The input device 92 is mounted on the manned vehicle 9. A driver's cabin which a worker gets on is provided in the manned vehicle 9. The input device 92 is arranged in the driver's cabin of the manned vehicle 9.

The input device 92 is operated by the worker on the driver's cabin of the manned vehicle 9. As the input device 92, at least one of a computer keyboard, a button, a switch, and a touch panel is exemplified. The worker can operate the input device 92. The input device 92 generates input data by being operated by the worker. The input data generated by the input device 92 is output to the control device 90.

The control device 90 includes a communication unit 90A and an input data acquisition unit 90B.

The communication unit 90A transmits data to the management device 3 through the communication system 4. Also, the communication unit 90A transmits data to the unmanned vehicle 2 through the communication system 4. Also, the communication unit 90A receives data transmitted from the management device 3 through the communication system 4. Also, the communication unit 90A receives data transmitted from the unmanned vehicle 2 through the communication system 4.

From the input device 92, the input data acquisition unit 90B acquires input data generated by operation of the input device 92. In the present embodiment, the worker operates the input device 92 in such a manner that the password data displayed on the display device 33 of the unmanned vehicle 2 is input into the control device 90. That is, the worker gets on the driver's cabin of the unmanned vehicle 2 and sees the password data displayed on the display device 33. After memorizing or writing down the password data displayed on the display device 33, the worker gets on the driver's cabin of the manned vehicle 9 and operates the input device 92 in such a manner that the password data is input into the control device 90. The input data acquisition unit 90B acquires input data indicating the password data. The communication unit 90A transmits the input data indicating the password data to the management device 3.

The management device 3 acquires the password data from the control device 90. In a case where the password data is acquired, the automatic mode permission unit 3C generates a permission command on the basis of the password data. The automatic mode permission unit 3C outputs the permission command generated on the basis of the password data to the control device 30. The permission command acquisition unit 30I acquires the permission command generated in the automatic mode permission unit 3C on the basis of the password data. The switching unit 30E switches the unmanned vehicle 2 from the manual mode to the automatic mode in a case where the permission command is acquired.

[Control Method]

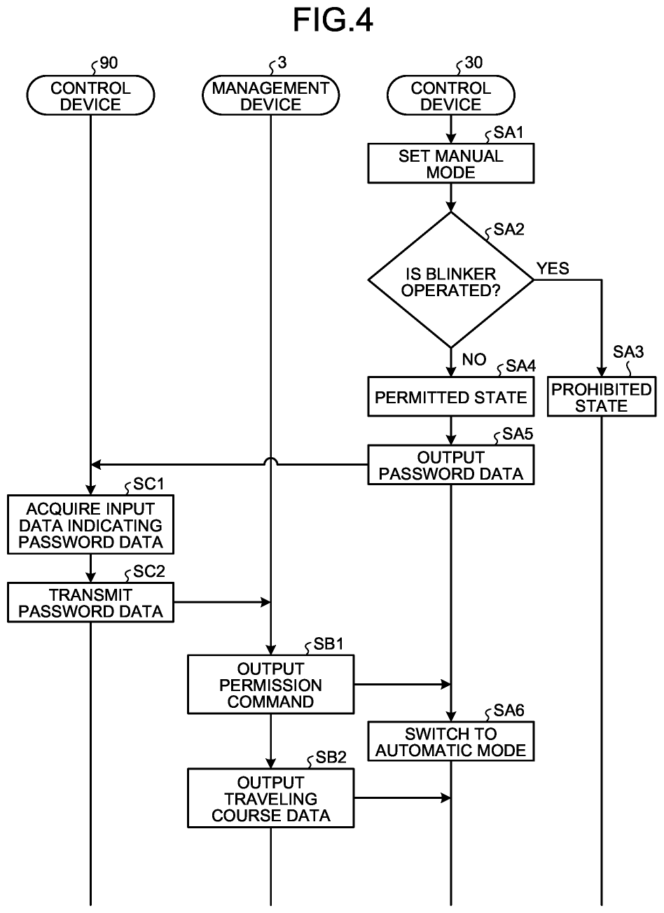

FIG. 4 is a flowchart illustrating an example of a control method of the unmanned vehicle 2 according to the present embodiment. For example, in maintenance or the like of the unmanned vehicle 2, the switching unit 30E of the control device 30 sets the unmanned vehicle 2 to the manual mode (Step SA1).

On the basis of operation data of the blinker operating device 31, the determination unit 30F determines whether the blinkers 20 are operated in the manual mode (Step SA2).

In a case where it is determined in Step SA2 that the blinkers 20 are operated (Step SA2: YES), the command unit 30G outputs the second command to set the switching from the manual mode to the automatic mode to the prohibited state. As a result, the switching from the manual mode to the automatic mode is brought into the prohibited state in the unmanned vehicle 2. No password data is displayed on the display device 33 (Step SA3).

In a case where it is determined in Step SA2 that the blinkers 20 are not operated (Step SA2: NO), the command unit 30G outputs the first command to set the switching from the manual mode to the automatic mode to the permitted state. As a result, in the unmanned vehicle 2, the switching from the manual mode to the automatic mode is brought into the permitted state (Step SA4).

When the switching from the manual mode to the automatic mode is in the permitted state, the password data output unit 30H outputs the password data. The password data is displayed on the display device 33 (Step SA5).

The worker gets on the driver's cabin of the unmanned vehicle 2 and checks the password data displayed on the display device 33. After memorizing or writing down the password data displayed on the display device 33, the worker operates the input device 92 of the manned vehicle 9 in such a manner that the password data is input into the control device 90. The input data acquisition unit 90B acquires the input data indicating the password data (Step SC1).

The communication unit 90A of the control device 90 transmits the input data indicating the password data to the management device 3 (Step SC2).

The management device 3 acquires the password data from the control device 90. In a case where the password data is acquired, the automatic mode permission unit 3C generates a permission command on the basis of the password data. The automatic mode permission unit 3C outputs the permission command generated on the basis of the password data to the control device 30 (Step SB1).

The permission command acquisition unit 30I acquires the permission command generated in the automatic mode permission unit 3C on the basis of the password data. The switching unit 30E switches the unmanned vehicle 2 from the manual mode to the automatic mode in a case where the permission command is acquired (Step SA6).

In the management device 3, the traveling course data generation unit 3H generates traveling course data. The communication unit 3A transmits the generated traveling course data to the control device 30 of the unmanned vehicle 2 through the communication system 4 (Step SB2).

In the control device 30, the traveling course data acquisition unit 30B acquires the traveling course data. The unmanned vehicle 2 set to the automatic mode starts operation on the basis of the traveling course data. The traveling control unit 30C controls the traveling device 21 in such a manner that the unmanned vehicle 2 travels according to a target traveling route CR defined by the traveling course data. The blinker control unit 30D controls the blinkers 20 on the basis of blinker data included in the traveling course data.

[Effect]

As described above, according to the present embodiment, the determination unit 30F determines whether the blinkers 20 are operated in the manual mode. The traveling control unit 30C controls a traveling state of the unmanned vehicle 2 in the automatic mode on the basis of determination data of the determination unit 30F. The traveling control unit 30C prevents the unmanned vehicle 2 from traveling in a case where it is determined that the blinkers 20 are operated in the manual mode. As a result, the unmanned vehicle 2 is prevented from traveling in the automatic mode in a state in which the blinkers 20 are operated unnecessarily.

On the basis of the determination data of the determination unit 30F, the command unit 30G outputs a first command to set switching from the manual mode to the automatic mode to a permitted state, or a second command to set the switching to a prohibited state. As a result, the unmanned vehicle 2 is prevented from operating in the automatic mode in a state in which the blinkers 20 are operated unnecessarily.

For example, there is a possibility that the unmanned vehicle 2 starts traveling in the automatic mode with the blinkers 20 being operated unnecessarily in a case where a state in which the blinker operating device 31 is operated in the manual mode is left unattended, password data is displayed on the display device 33 in a state in which the blinkers 20 are operated, and the unmanned vehicle 2 is switched from the manual mode to the automatic mode. As a result, there is a possibility that a worker on the manned vehicle 9 or other workers present at a work site cannot correctly recognize a moving direction of the unmanned vehicle 2.

In the present embodiment, when a state in which the blinker operating device 31 is operated in the manual mode is left unattended and the blinkers 20 are in a state of being operated, the password data is not displayed on the display device 33, and switching from the manual mode to the automatic mode is prohibited. Thus, the unmanned vehicle 2 is prevented from operating in the automatic mode in a state in which the blinkers 20 are operated unnecessarily.

After the switching from the manual mode to the automatic mode is set to the permitted state, the password data such as a one time password is displayed on the display device 33. When the password data is transmitted to the management device 3, a permission command is transmitted from the management device 3 to the control device 30. The switching unit 30E of the control device 30 switches the manual mode to the automatic mode after acquiring the permission command from the management device 3. As a result, the unmanned vehicle 2 can operate in the automatic mode after the permission command is acquired from the management device 3.

[Computer System]

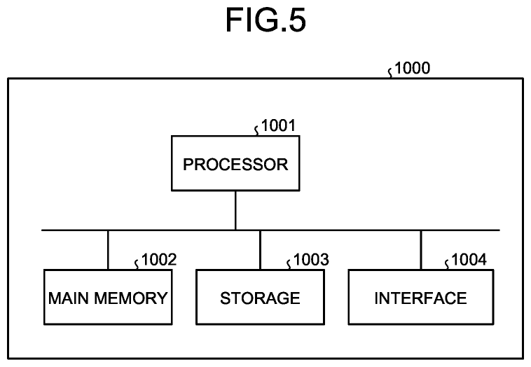

FIG. 5 is a block diagram illustrating an example of a computer system 1000. Each of the above-described management device 3, control device 30, and control device 90 includes the computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. The above-described function of the management device 3 and function of the control device 30 are stored as programs in the storage 1003. The processor 1001 reads a program from the storage 1003, develops the program into the main memory 1002, and executes the above-described processing according to the program. Note that the program may be distributed to the computer system 1000 through a network.

According to the above-described embodiment, the computer system 1000 can set switching from the manual mode to the automatic mode to a permitted state in a case where the blinkers 20 provided in the unmanned vehicle 2 operating in the manual mode or the automatic mode are not operated in the manual mode, and can set the switching from the manual mode to the automatic mode to a prohibited state in a case where the blinkers 20 are operated in the manual mode.

### Different Embodiment

In the above-described embodiment, when the blinkers 20 are not operated in the manual mode, switching from the manual mode to the automatic mode is set to the permitted state, and password data is displayed on the display device 33. As a condition of displaying the password data on the display device 33, other conditions may be combined in addition to a condition that the blinkers 20 are stopped. For example, in a case where a changeover switch to perform switching between the manual mode and the automatic mode is provided in the driver's cabin of the unmanned vehicle 2, a condition that the changeover switch is switched to the automatic mode may be included in a condition of displaying the password data on the display device 33. Also, in a case where a gearshift is provided in the driver's cabin of the unmanned vehicle 2, a condition of displaying the password data on the display device 33 may include a condition that the gearshift is operated in a parking mode. Also, in a case where a brake lock switch is provided in the driver's cabin of the unmanned vehicle 2, a condition of displaying the password data on the display device 33 may include a condition that the brake lock switch is turned off or on. Also, a condition of displaying the password data on the display device 33 may include a condition that the position detection device 28 operates normally. Also, a condition of displaying the password data on the display device 33 may include a condition that the unmanned vehicle 2 is stopped (condition that a vehicle speed is zero).

In the above-described embodiment, the password data is displayed on the display device 33. Password data may be output by an output device such as a printing device.

In the above-described embodiment, a worker inputs password data into the control device 90 by operating the input device 92 provided in the manned vehicle 9, and the password data is transmitted from the control device 90 to the management device 3. Password data may be transmitted to a management device 3 without passing through a manned vehicle 9. For example, in a case of having an information terminal, a worker may operate the information terminal and input password data displayed on a display device 33 into the information terminal. The information terminal may transmit the password data to the management device 3 through a communication system 4.

In the above-described embodiment, switching from the manual mode to the automatic mode is performed by an input of the password data. Switching from a manual mode to an automatic mode may be performed by an arbitrary method without utilization of password data.

Note that in the above-described embodiment, at least a part of the function of the control device 30 of the unmanned vehicle 2 may be provided in the management device 3, and at least a part of the function of the management device 3 may be provided in the control device 30.

Note that in the above-described embodiment, traveling course data is generated in the management device 3, and the unmanned vehicle 2 travels according to the traveling course data transmitted from the management device 3. A control device 30 of an unmanned vehicle 2 may generate traveling course data. That is, the control device 30 may include a traveling course data generation unit. Also, each of a management device 3 and control device 30 may include a traveling course data generation unit.

Note that in the above-described embodiment, the unmanned vehicle 2 is a dump truck that is a kind of a transporter vehicle. An unmanned vehicle 2 may be a work machine including working equipment, such as an excavator or a bulldozer.

### REFERENCE SIGNS LIST

1 CONTROL SYSTEM
2 UNMANNED VEHICLE
3 MANAGEMENT DEVICE
3A COMMUNICATION UNIT
3B TRAVELING COURSE DATA GENERATION UNIT
3C AUTOMATIC MODE PERMISSION UNIT
4 COMMUNICATION SYSTEM
5 CONTROL FACILITY
6 WIRELESS COMMUNICATION EQUIPMENT
7 LOADER
8 CRUSHER
9 MANNED VEHICLE
20 BLINKER
21 TRAVELING DEVICE
22 VEHICLE BODY
23 DUMP BODY
24 DRIVE DEVICE
25 BRAKE DEVICE
26 STEERING DEVICE
27 WHEEL
27F FRONT WHEEL
27R REAR WHEEL
28 POSITION DETECTION DEVICE
29 WIRELESS COMMUNICATION EQUIPMENT
30 CONTROL DEVICE
30A COMMUNICATION UNIT
30B TRAVELING COURSE DATA ACQUISITION UNIT
30C TRAVELING CONTROL UNIT
30D BLINKER CONTROL UNIT
30E SWITCHING UNIT
30F DETERMINATION UNIT
30G COMMAND UNIT
30H PASSWORD DATA OUTPUT UNIT
301 PERMISSION COMMAND ACQUISITION UNIT
31 BLINKER OPERATING DEVICE
32 TRAVELING OPERATING DEVICE
33 DISPLAY DEVICE
90 CONTROL DEVICE
90A COMMUNICATION UNIT
90B INPUT DATA ACQUISITION UNIT
91 WIRELESS COMMUNICATION EQUIPMENT
92 INPUT DEVICE
CR TARGET TRAVELING ROUTE
CR1 TARGET TRAVELING ROUTE
CR2 TARGET TRAVELING ROUTE
HL TRAVELING PATH
PA WORKPLACE
DPA DIRT DUMPING PLACE
LPA LOADING PLACE

1. A control system of an unmanned vehicle, comprising:
a switching unit that can switch the unmanned vehicle, which has a blinker, between a manual mode and an automatic mode;
a determination unit that determines whether the blinker is operated in the manual mode; and
a traveling control unit that controls traveling of the unmanned vehicle on the basis of determination data of the determination unit.

2. The control system of the unmanned vehicle according to claim 1, wherein
the traveling control unit prevents the unmanned vehicle from traveling in the automatic mode in a case where it is determined that the blinker is operated.

3. The control system of the unmanned vehicle according to claim 1, further comprising
a command unit that outputs, on the basis of the determination data of the determination unit, a first command to set switching from the manual mode to the automatic mode to a permitted state, or a second command to set the switching to a prohibited state.

4. The control system of the unmanned vehicle according to claim 3, wherein
the command unit outputs the first command in a case where it is determined that the blinker is not operated in the manual mode, and outputs the second command in a case where it is determined that the blinker is operated in the manual mode.

5. The control system of the unmanned vehicle according to claim 3, further comprising
a password data output unit that outputs password data in the permitted state.

6. The control system of the unmanned vehicle according to claim 5, further comprising
a permission command acquisition unit that acquires a permission command generated on the basis of the password data, wherein
the switching unit performs switching from the manual mode to the automatic mode in a case where the permission command is acquired.

7. A control method of an unmanned vehicle, comprising:
outputting determination data obtained by determining whether a blinker provided in the unmanned vehicle that operates in a manual mode or an automatic mode is operated in the manual mode, and
controlling traveling of the unmanned vehicle on the basis of the determination data.
